(19) United States
(12) Patent Application Publication
(10) Pub. No.: US 2002/0103079 A1
(43) Pub. Date: Aug. 1, 2002

(54) PROCESS FOR THE PREPARATION OF CATALYSTS FOR DEHYDROGENATION

(76) Inventors: FABIENNE LEPELTIER, RUEIL MALMAISON (FR); SYLVIE ROBERT, RUEIL MALMAISON (FR); JEAN-PAUL BOITIAUX, POISSY (FR); BLAISE DIDILLON, RUEIL MALMAISON (FR); OLIVER CLAUSE, CHATOU (FR)

Correspondence Address: MILLEN WHITE ZELANO & BRANIGAN, ARLINGTON COURTHOUSE PLAZA 1, SUITE 1400, 2200 CLARENDON BOULEVARD, ARLINGTON, VA, 22201

(21) Appl. No.: 08/701,878

(22) Filed: Aug. 23, 1996

Related U.S. Application Data
(63) Continuation of application No. 08/239,060, filed on May 6, 1994, now abandoned.

(30) Foreign Application Priority Data
May 6, 1993 (FR) 93/05.552

(51) Int. Cl. B01J 23/58

(52) U.S. Cl. 502/328; 502/330; 502/226; 502/227; 502/223; 502/305; 502/306; 502/308; 502/309; 502/325; 502/326; 502/349; 502/350; 502/352

(57) ABSTRACT

A process for the preparation of a catalyst is described, said catalyst comprising at least one inorganic refractory support, at least one halogen or halogenated compound at a content greater than 0.1% by weight, at least one metal from group VIII of the periodic classification (platinum, palladium, nickel and ruthenium) and at least one additional metal M selected from germanium, tin, lead, iron, titanium and chromium. The process is characterised in that said metal M is introduced in the form of at least one orqanometallic complex. The catalyst prepared in accordance with the invention may be used for dehydrogenation reactions, particularly of paraffinic hydrocarbons and olefinic hydrocarbons.

The present invention concerns a novel process for the preparation of a catalyst containing a halogen or halogenated compound, containing at least one metal from group VIII of the periodic classification of the elements which is modified by addition of at least one additional metal which must interact with the base metal to produce a more effective, novel catalyst, and optionally at least one further metal selected from the group constituted by the alkali metals and/or a metalloid such as sulphur.

There is a large number of patents and published documents which demonstrate that addition of catalyst promoters to a base metal improves catalyst quality. These elements are added in various forms such as salts or organometallic compounds. In general, more active or more selective catalysts are produced, which can occasionally be more stable than the corresponding monometallic catalyst.

These catalysts comprise at least one support, at least one halogen or halogenated compound, at least one metal from the group VIII family, and an additional metal (hereinafter termed metal M) selected from germanium, tin, lead, iron, titanium and chromium. The catalyst optionally and preferably also contains at least one alkali or alkaline-earth metal and also optionally may contain an element selected from the metalloids (for example sulphur), as indicated above.

They are of particular use in catalytic dehydrogenation of a hydrocarbon feedstock comprising mainly paraffins containing 2 to 5 carbon atoms per molecule, ie, C₂-C₅ paraffins. The dehydrogenation reaction is generally carried out at a pressure of between 0.2 and 20 bars absolute (1 bar=0.1 MPa), preferably at a pressure of between 1 and 10 bars absolute, and at a temperature of between 400° C. and 800° C. depending on the nature of the feedstock. The temperature is advantageously between 560° C. and 700° C. for a feedstock containing mainly propane, between 450° C. and 600° C. for a feedstock containing mainly isobutane and between 400° C. and 550° C. for a feedstock containing mainly isopentane. The feedstock may also contain unsaturated hydrocarbons containing 2 to 5 carbon atoms per molecule. Hydrogen can advantageously be used as a diluent.

The hydrogen/hydrocarbon molar ratio is generally between 0 and 20, preferably between 0 and 6. Recommended bulk flow rates (with respect to liquid feedstock) are generally 0.5 to 100 h⁻¹, preferably 1.5 to 50 h⁻¹.

A large number of studies have been conducted on dehydrogenation catalyst formulations. Supported metallic catalysts have been particularly described in U.S. Pat. No. 3,531,543 and U.S. Pat. No. 3,909,451. They contain a metallic platinum based phase modified by an additional metal such as tin, supported on an inorganic refractory oxide such as alumina. Introduction of metal M is advantageously carried out using an orqanometallic compound of said metal M. This method of introducing metal M has already been described in U.S. Pat. No. 3,531,543. In this document, the lowest possible weight content is sought for these catalysts.

The invention concerns a process for the preparation of a catalyst consisting in introducing at least one metal from group VIII of the periodic classification of the real elements, at least one alkali or alkaline-earth metal, at least one halogen or halogenated compound and at least one additional metal M selected from the group constituted by germanium, tin, lead, iron, titanium and chromium into the calcined and activated catalytic mass comprising at least one support and termed a precatalyst.

Preferably, the process is characterized in that:

a) in a first step of said preparation, said precatalyst is prepared offsite, the precatalyst being optionally dried at this point and then being calcined,

b) the precatalyst is then activated in a neutral atmosphere (inert gas) or a reducing atmosphere and,

c) in a second step of said preparation, said additional metal M is introduced into the precatalyst by bringing it into contact with at least one organic compound of additional metal M.

More precisely, we have now surprisingly discovered (and this constitutes an object of the invention), a catalyst characterised in that it has a high halogen or halogenated compound content (greater than 0.1%) and in that it is prepared by bringing at least one orqanometallic compound of additional metal M into contact with a precatalyst. The precatalyst of the present invention is a catalyst comprising at least one support, at least one metal from group VIII of the periodic classification of the elements, optionally at least one alkali or alkaline-earth metal, and optionally at least one metalloid. The precatalyst does not contain said additional metal M.

Additional metal M is added in the liquid phase or in the gaseous phase. The additional metal M fixing operation can be carried out between 20° C. and 500° C.

We have discovered that catalysts prepared in accordance with the invention exhibit increased activity and lifetime and improved regenerability compared to prior art catalysts prepared in accordance with prior art techniques. The support in a catalyst according to the invention comprises at least one refractory oxide which is generally selected from oxides of metals from groups IIA, IIIA or IVA of the periodic classification of the elements, such as magnesium, aluminium or silicon oxides, either alone or mixed together or mixed with other oxides of elements of the periodic classification. Alumina is the preferred support, advantageously with a specific surface area of between 50 and 400 m² per gram, preferably between 100 and 400 m² per gram.

The group Viii metal is selected from metals such as platinum, palladium, nickel and ruthenium, preferably platinum.

The halogen or halogenated compound is selected from fluorine, chlorine, bromine or iodine, either alone or mixed together. Chlorine or chlorinated compounds are preferred.

Additional metal M is selected from germanium, tin, lead, iron, titanium and chromium. Tin and germanium are the preferred elements.

The catalyst optionally and preferably contains at least one alkali or alkaline-earth metal such as potassium. Optionally, the catalyst may also contain sulphur.

The catalyst of the invention preferably contains the following proportions by weight with respect to the support:

(a) 0.01 to 2% of at least one noble metal from the group VIII family,

(b) 0.5 to 3% of at least one halogen or halogenated compound,

(c) 0.01 to 3% of at least one additional element M,

(d) 0.5 to 3% of at least one alkali or alkaline-earth metal when the catalyst contains such metal.

A preferred formula for a catalyst according to the invention comprises 0.1 to 1% by weight of platinum, 0.1 to 2% by weight of chlorine, 0.01 to 1% by weight of additional metal M and 0.1 to 1.5% by weight of potassium. The catalyst may contain 0.005 to 1% by weight of sulphur.

The precatalyst, precursor and final catalyst may be prepared using any technique known to the skilled person.

In a preferred technique for the preparation of a catalyst according to the invention, the precatalyst is prepared from a preformed support using conventional methods consisting in impregnating the support by means of solutions of compounds of the elements which are to be introduced. Either a common solution or separate solutions of the metals present in the catalyst may be used, in any order. When several solutions are used, the catalyst may be intermediately dried and/or calcined. The final step is generally calcining, for example between 500° C. and 1000° C.; preferably in the presence of unlimited oxygen, for example by purging with air.

When the catalyst contains an alkali or alkaline-earth metal, it may be introduced into the support by means of an aqueous solution containing decomposable salts of said metal in the form of the nitrate, carbonate or acetate, for example potassium carbonate.

The group VIII metal is preferably introduced by impregnating the support with an aqueous solution of a halogenated compound. Platinum is preferably introduced as chloroplatinic acid. Following introduction of the group VIII metal, the product obtained is calcined following optional drying; calcining is preferably carried out at a temperature of between 400° C. and 700° C. in the presence of a halogenated organic compound. Halogenated organic compounds are selected, for example, from the group formed by carbon tetrachloride, chloroform, dichloromethane and dichloropropane.

Before introducing metal M, the precatalyst may optionally be dried and is then calcined in an oxidising atmosphere between 300° C. and 650° C. According to the invention, the precatalyst is then activated in a reducing (hydrogen) or neutral (nitrogen or other inert gas) atmosphere. The preferred method is high temperature activation in hydrogen, for example between 300° C. and 600° C. Reduction may consist, for example, in slowly raising the temperature in a current of hydrogen to the maximum reduction temperature, for example between 300° C. and 600° C., then maintaining this temperature under hydrogen for 1 to 6 hours.

Metal M is introduced following adjustment of the temperature to the desired value of between 20° C. and 500° C., preferably in a current of hydrogen.

The impregnating solvent is then eliminated if necessary and the process is normally concluded by calcining, for example between 300° C. and 600° C.; preferably in the presence of unlimited oxygen, for example by purging with air for several hours.

Additional metal M is introduced into the precatalyst in the form of at least one orqanometallic compound or an alcoholate selected from the group formed by complexes, in particular carbonyl or polyketone complexes of metal M and metallic hydrocarbons of metal M such as alkyls, cycloalkyls, aryls, metal alkylaryls and metal arylalkyls.

Metal M is advantageously introduced by means of a solution of the alcoholate or organometallic compound of said metal M in an organic solvent. organo-halogen compounds of metal M may also be employed. The following metal M compounds may in particular be mentioned: hexacarbonyl iron, titanium isopropylate, dichlorodicyclopentadienyl titanium, tetrabutyl tin, tetramethyl tin, tetrapropyl germanium, diphenyl tin and tetraethyl lead.

The impregnating solvent is selected from the group constituted by oxygenated organic solvents containing 2 to 8 carbon atoms per molecule, paraffinic, naphthenic or aromatic hydrocarbons containing 6 to 15 carbon atoms per molecule and halogenated organic compounds containing 1 to 15 carbon atoms per molecule. The following may be cited: ethanol, tetrahydrofuran, n-heptane, methylcyclohexane, toluene and chloroform. The solvents may be used alone or mixed together.

A preferred method of preparing a catalyst in accordance with the invention is:

(a) a support, optionally containing an alkali or alkaline-earth compound, is impregnated using an aqueous solution containing at least one group VIII metal. A catalytic mass termed the “precatalyst” is thus obtained,

(b) the catalytic mass (precatalyst) is dried,

(c) the catalytic mass obtained is calcined and then, in accordance with the invention,

(d) the catalytic mass is reduced,

(e) the reduced catalytic mass is brought into contact —with the organic compound of metal M, either pure or dissolved in a hydrocarbon solvent,

(f) the solvent is eliminated if necessary,

(g) the catalytic mass containing platinum or a noble metal of the platinum family and additional metal M is calcined.

The following examples illustrate the invention without in any way limiting its scope.

### EXAMPLE 1

Three catalysts A to C each containing 0.6% by weight of platinum, 0.45% by weight of tin and 1% by weight of potassium were prepared. An alumina support having a specific surface area of 220 m² per gram and porous volume of 0.60 cm³ per gram was used.

Preparation of Catalyst A (Comparative) Without Chlorine

Catalyst A was prepared from 80 g of alumina support. The solid was first calcined at 530° C. for 2 hours in a current of air at 80 liters per hour. 48 cm³ of an aqueous solution containing 1.4 g of potassium carbonate was added and the sample was calcined for 2 hours at 530° C.

Platinum impregnation was carried out by adding 400 cm³ of a solution of toluene containing 0.97 g of platinum bisacetylacetonate to 80 g of solid. These were left in contact for 24 hours, then dried for 1 hour at 120° C. and calcined for 2 hours at 530° C. The catalyst was then reduced for 2 hours at 450° C. in a 80 liters per hour current of hydrogen.

15 g of the reduced product, termed the “precatalyst” containing potassium and platinum, was impregnated with tin by adding 45 cm³ of a solution of n-heptane containing 0.4 g of tetrabutyl tin. This was left in contact for 8 hours at room temperature in a 85 liters per hour current of hydrogen. The solid obtained was drained then dried at 120° C. and calcined at 530° C. for 2 hours.

Preparation of catalyst B (According to the Invention) Containing 0.6% of Chlorine

Platinum and chlorine were introduced into 80 g of alumina support containing 1% by weight of potassium and prepared under the same conditions to those of the preceding example by adding 48 cm³ of an aqueous solution of hexachloroplatinic acid containing 0.48 g of platinum. This was left in contact for 4 hours, then dried for 1 hour at 120° C. and calcined for 2 hours at 530° C. The catalyst was then reduced for 2 hours at 450° C. in a 80 liters per hour current of hydrogen. Tin was then introduced using tetrabutyl tin on 15 g of the product termed the “precatalyst” containing platinum, potassium and chlorine under the same conditions to those of the preceding example.

Preparation of Catalyst C (in Accordance with the Invention) Containing 1.5% of Chlorine

Platinum and chlorine were introduced into 80 g of alumina support containing 1% by weight of potassium and prepared under the same conditions to those of the preceding example by adding 48 cm³ of an aqueous solution of hexachloroplatinic acid and hydrochloric acid containing a total of 0.48 g of platinum and 1.2 g of chlorine. This was left in contact for 4 hours, then dried for 1 hour at 120° C. and calcined for 2 hours at 530° C. Tin was then introduced using tetrabutyl tin on 15 g of the product (or precursor) containing platinum, potassium and chlorine under the same conditions to those of the preceding example.

### EXAMPLE 2

A dehydrogenation test was carried out on catalysts A, B and C using a feedstock of pure isobutane (99.9% isobutane and 0.1% n-butane) in an isothermal tube reactor operating in descending flow mode at atmospheric pressure. The catalyst was first reduced for 2 hours at 530° C. in the reactor in a 16.5 liters per hour current of hydrogen. 16.5 liters per hour of isobutane was then injected, corresponding to a hydrogen/hydrocarbon molar ratio of 1 and a bulk flow rate of 100 h⁻¹, the temperature then being stabilised at 580° C. Analysis of the gaseous effluents was conducted using gas phase chromatography.

The results obtained under these conditions, expressed as weight %, are shown in Table 1.

TABLE 1

| | | iC₄ | iC₄ | iC₄ |
|---|---|---|---|---|
| | Time | conversion | selectivity | yield |
| Catalyst | (h) | (wt %) | (wt %) | (wt %) |
| A | 2 | 17.3 | 94.2 | 16.3 |
| | 4 | 14.3 | 94.8 | 13.5 |
| | 6 | 13.4 | 94.8 | 12.7 |
| B | 2 | 22.6 | 95.8 | 21.6 |
| | 4 | 21.4 | 95.8 | 20.5 |
| | 6 | 21.3 | 95.9 | 20.4 |
| C | 2 | 36.0 | 93.0 | 33.5 |
| | 4 | 33.7 | 93.0 | 31.3 |
| | 6 | 33.7 | 93.1 | 31.4 |

These results clearly show that catalysts B and C, prepared in accordance with the invention with respective chlorine contents of 0.6 and 1.5% by weight, were far more selective than catalyst A prepared in accordance with the prior art and which did not contain chlorine.

### EXAMPLE 3

Preparation of Catalyst D (Comparative) Containing 1.5% Chlorine

Catalyst D, with the same composition as catalyst C, was prepared using prior art techniques. It contained 0.6% by weight of platinum, 0.45% by weight of tin, 1% by weight of potassium and 1.5% of chlorine. The support was an alumina with a specific surface area of 220 m² per gram and a porous volume of 0.60 cm³ per gram.

500 cm³ of an aqueous solution of hydrochloric acid was added to 100 g of the alumina support. This was left in contact for 3 hours, drained and dried for 1 hour at 120° C. Platinum and tin impregnation was then carried out on this dried chlorine-containing product by adding 150 cm³ of a solution of hexachloroplatinic acid and stannic chloride to the solid. The concentration of platinum in the solution was 4.05 g per liter and the concentration of tin was 3.04 g per liter. This was left in contact for 6 hours, then dried for 1 hour at 120° C. and calcined for 2 hours at 530° C. Potassium was introduced into the calcined product by adding 60 cm³ of an aqueous solution containing 1.7 g of potassium carbonate. The sample was then dried at 120° C. and calcined for 2 hours at 520° C.

### EXAMPLE 4

A dehydrogenation test was carried out on catalysts C and D using a feedstock of pure isobutane (99.9% isobutane and 0.1% n-butane) in an isothermal tube reactor operating in descending flow mode at atmospheric pressure. 3.5 g of the catalyst was reduced for 2 hours in the reactor at 530° C. in a 20 liters per hour current of hydrogen. 20 liters per hour of isobutane was then injected, corresponding to a hydrogen/hydrocarbon molar ratio of 1 and a bulk flow rate of 14 h⁻¹. The temperature was raised to 560° C. then to 580° C. Analysis of the gaseous effluents was carried out using gas phase chromatography.

The results obtained under these conditions, expressed as weight %, are shown in Table 2.

TABLE 2

| | | iC₄ | iC₄ | iC₄ |
|---|---|---|---|---|
| | Time | conversion | selectivity | yield |
| Catalyst | (h) | (wt %) | (wt %) | (wt %) |
| C | 1 | 47.5 | 87.0 | 41.3 |
| | 4 | 43.4 | 89.4 | 38.8 |
| | 6 | 42.8 | 89.8 | 38.4 |
| D | 1 | 38.0 | 85.0 | 32.3 |
| | 4 | 33.6 | 88.3 | 29.7 |
| | 6 | 32.4 | 89.5 | 29.0 |

Catalyst C, prepared in accordance with the invention from tetrabutyl tin, was considerably more active than catalyst D prepared using prior art techniques.

1. A process for the preparation of a catalyst consisting in introducing at least one metal from group VIII of the periodic classification of the elements, at least one alkali or alkaline-earth metal, at least one halogen or halogenated compound, at least one additional metal m selected from the group constituted by germanium, tin, lead, iron, titanium and chromium into a calcined and activated catalytic mass comprising at least one support and termed a precatalyst.

2. Process according to claim 1, characterised in that
a) in a first step X said preparation, said precatalyst is prepared offsite, the precatalyst being optionally dried at this point and then calcined,
b) the precatalyst is then activated in a neutral atmosphere (inert gas) or a reducing atmosphere and,
c) in a second step of said preparation, said additional metal M is introduced into the precatalyst by bringing it into contact with at least one organic compound of additional metal M.

3. Process according to claim 1 wherein the group VIII metal is selected from the group constituted by platinum, palladium, nickel and ruthenium.

4. Process according to claim 1 wherein the support comprises at least one refractory oxide.

5. Process according to claim 1 wherein the catalyst further contains at least one metalloid.

6. Process according to claim 5 wherein the metalloid is sulphur.

7. Process according to claim 1 wherein, during the course of said second step, the organic compound of additional metal M is introduced in the liquid or gaseous phase.

8. Process according to claim 1 wherein, during the course of said second step, the organic compound of additional metal M is introduced into the catalyst in at least one impregnating solvent, the latter being a hydrocarbon solution.

9. Process according to claim 1 wherein the precatalyst is activate in a reducing atmosphere in the presence of hydrogen between 300° C. and 600° C.

10. Process according to claim 8 wherein additional metal M is introduced into the precatalyst in the form of at least one organometallic compound or alcoholate.

11. Process according to claim 10, wherein said organometallic compound or alcoholate is selected from the group formed by carbonyl or polyketone complexes of metal M and metallic hydrocarbons of metal M such as alkyls, cycloakyls, aryls, alkylaryls and arylalkyls.

12. Process according to claim 8 wherein said organic compound of metal M is selected from the group cnstituted by hexacarbonyl iron, titanium isopropylate, dichlorodicyclo-pentadienyl titanium, tetrabutyl tin, tetramethyl tin, tetrapropyl germanium, diphenyl tin and tetraethyl lead.

13. Process according to claim 8 wherein said impregnating solvent is selected from the group constituted by oxygenated organic solvents containing 2 to 8 carbon atoms per molecule, paraffinic, naphthenic or aromatic hydrocarbons containing 6 to 15 bon atoms per molecule and halogenated organic compounds containing 1 to 15 carbon atoms per molecule.

14. Process according claim 13 wherein the impregnating solvent is selected from the group constituted by ethanol, tetrahydrofuran, n-heptane, methylcyclohexane, toluene and chloroform.

15. Use in paraffin dehydrogenation reactions of a catalyst prepared in accordance with claim 1.
